(19) United States
(12) Patent Application Publication
(10) Pub. No.: US 2011/0309764 A1
(43) Pub. Date: Dec. 22, 2011

(54) GENERATOR OF EXCESS ELECTROMAGNETIC ENERGY

(76) Inventors: Vitalii Grigorovich Kriuk, Kiev (UA); Mykola Mykolaevisch Beldii, Kiev (UA); Vitalii Anatolievisch Iatsyshin, Kiev (UA)

(21) Appl. No.: 13/138,415

(22) PCT Filed: Feb. 18, 2010
(86) PCT No.: PCT/UA2010/000004

§ 371 Date: Aug. 11, 2011

(30) Foreign Application Priority Data
Feb. 26, 2009 (UA) A2009 01708

(51) Int. Cl. H01Q 1/26

(52) U.S. Cl. 315/248

(57) ABSTRACT

What is claimed is the generator of the excess electromagnetic energy (“generator”) for the illuminating gas discharge (fluorescent) lamps for the advertising devices, the interior spaces, the open spaces, etc. The basis of the generator is the Kriuk antenna (Ukrainian Patent No. 79626), with the Earth's electromagnetic field being excited in the limited (local) area around the said antenna and with the gas molecules in the gas discharge lamps being ionized until the light is generated. Owing to the fact that the electromagnetic field of the Kriuk antenna is limited spatially and that the Earth's electromagnetic field is relatively unlimited spatially, the excess electromagnetic energy is produced; that is to say that the coefficient of the energy conversion is greater than unity. It has been established by the experimental means that this coefficient is no less than for times unity (>400%), that is no less than the coefficient of the energy conversion of the known heat pumps (≈400%). The subjective estimation of the magnitude of the luminous flux from the gas discharge lamps with the objective monitoring of the magnitude of the energy consumption demonstrates that the said coefficient results in the magnitude of the order of twenty times unity (≈2000%).

### CROSS-REFERENCES TO RELATED APPLICATIONS

This application is a U.S. national phase application of a PCT application PCT/UA2010/000004 filed on 18 Feb. 2010, published as WO2010/098733, whose disclosure is incorporated herein in its entirety by reference, which PCT application claims priority of a Ukrainian patent application: UA a2009 01708 filed on 26 Feb. 2009.

### FIELD OF THE INVENTION

The invention belongs to the branch of the power engineering and can be used for the illumination of the advertising devices, the facilities and the open spaces, for example streets.

Currently, the world's leading countries carried out the intensive research and the patenting of the generators of the excess (surplus) energy. Moreover, in the absence of the comprehensive grounded theory of the source of the excess energy, it is associated with the energy of the physical vacuum. This is evidenced by both the summarizing articles in the periodicals [1] and in the monograph [2].

It is important that in [3], [4] and [5] the abstraction “physical vacuum” (“Environment”) existing in the modern science is filled with the electromagnetism, by which the natural time is determined; the natural time is associated with the motion of the celestial bodies: the Earth, the Moon, the Sun, etc. It gave the opportunity to claim this invention (theoretically justified and experimentally confirmed), which has no an analogues and a prototypes.

The invention sets the problem to obtain the excess electromagnetic energy from the Environment for the illuminating the gas-discharge lamps.

### BRIEF SUMMARY OF THE INVENTION

The problem is solved in this way. The discharge lamps for lighting are situated around the Kriuk antenna [6], the energy supply of which excites the electromagnetic field of the Earth and is consumed (expenditure). They are mainly supplied by the excess (overexpenditure) energy of the excited electromagnetic field of the Earth.

### DETAIL DESCRIPTION OF THE INVENTION

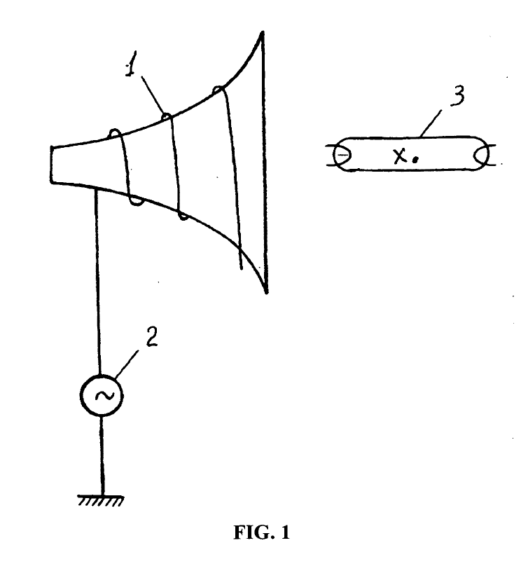

FIG. 1 schematically shows the generator of the excess electromagnetic energy (hereinafter referred to as “generator”).

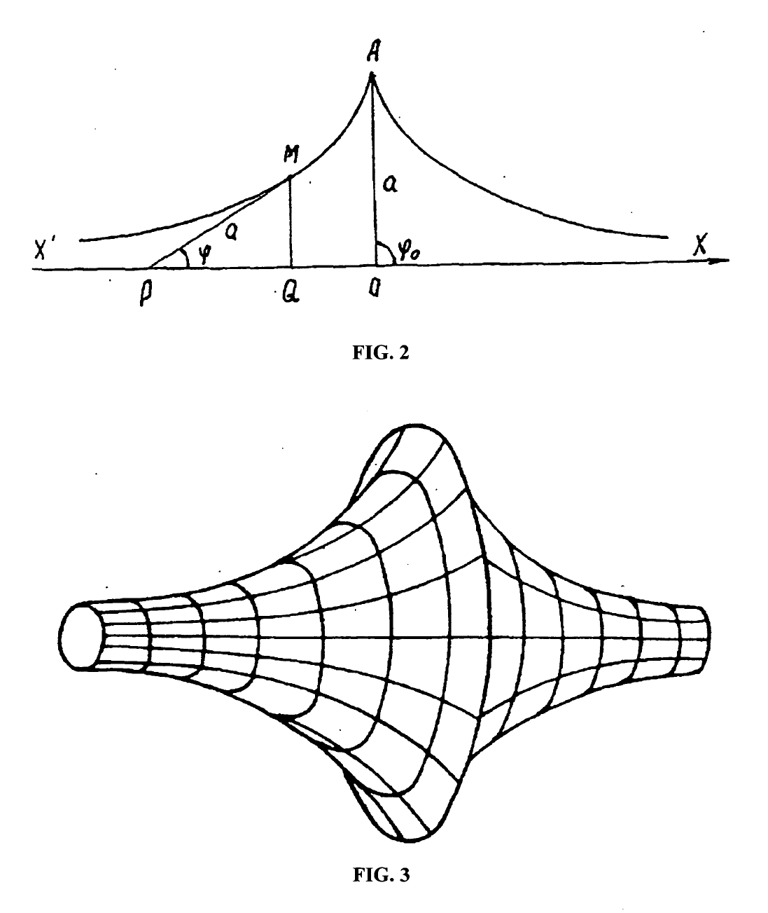

FIG. 2-5 illustrates the description of the generator. FIG. 2 shows the tractrix—the pseudo-sphere forming curve. The Kriuk antenna (hereinafter referred to as AK) has the half of the form of the tractrix;

FIG. 3 illustrates the appearance of the pseudo-sphere with the parallels and the meridians.

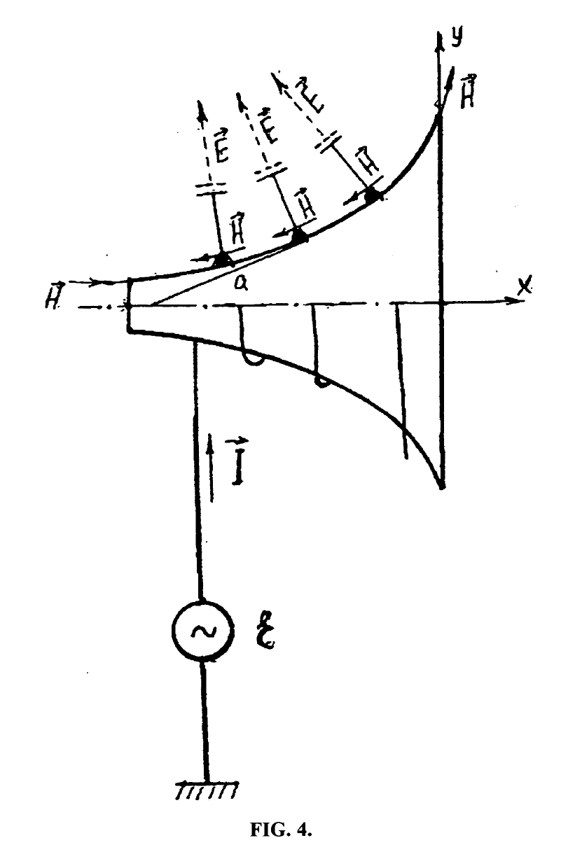

FIG. 4 shows the state of the electric and magnetic fields of the AK.

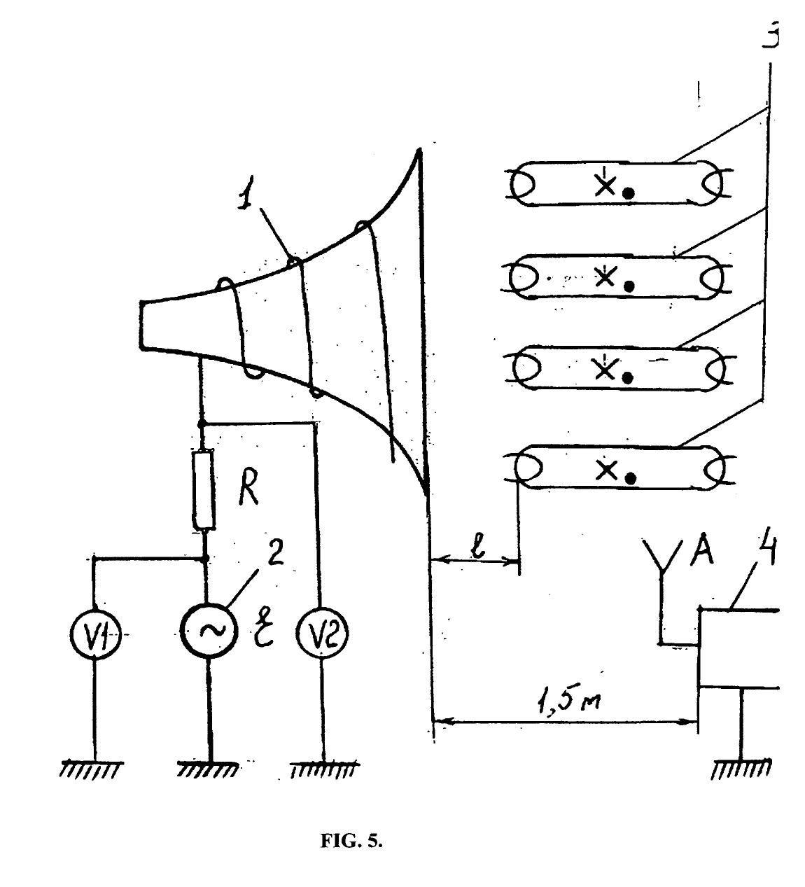

FIG. 5 illustrates the conditions of the experiment.

The generator of FIG. 1 contains: 1—The AK, 2—The power supply of the AK, 3—One of the lighting gas-discharge lamps.

Let us consider the operation of the generator.

To perform its functions the generator should have the two properties:
1. The generator must generate the excess electromagnetic energy—the energy of the Earth's electromagnetic field to illuminate the gas-discharge lamps.
2. The generator must ionize the gas molecules in the gas-discharge lamps, which causes the gas to glow.

In the description of the AK [6] (which is the induction coil in the form of the semi-pseudo-sphere) the resonant interaction of the electromagnetic energy of the AK itself and the electromagnetic energy of the Earth is theoretically grounded in the form of

$${\int }_{{V}_{Π}} div [ {E}^{->} {H}^{->} ] d {V}_{Π} = - {\int }_{{V}_{Π ⊕}} div [ {{E}^{->}}_{⊕} {{H}^{->}}_{⊕} ] d {V}_{Π ⊕} \qquad ( 1 )$$

where div └\vec{E}\vec{H}┘—the motion of the electromagnetic energy associated with the AK, in the volume of the pseudo-sphere Vn; −div└\vec{E}_{⊕}\vec{H}_{⊕}┘—the counter motion of the electromagnetic energy associated with the Earth in the volume of pseudo-sphere V_{π⊕}. However, motion equation (1) does not define the explicitly of the two above mentioned essential properties of the generator.

To determine the mentioned properties let us call our attention to the tractrix at FIG. 2. The tractrix is the locus of the one end of the segment AO=MP=a=const, the other end of which moves in the straight line X′X, forming the angle φ with this line. At any point of the tractrix the segment a=const is tangent to the tractrix; the line X′X is the asymptote of the tractrix. The tractrix is described by the equations

x=a cos φ+a ln tg(φ/2),

y=a sin φ. (2)

The rotation of the tractrixes around the asymptote X′X forms the surface in the form of the pseudo-sphere at the FIG. 3 [7, p. 822].

The results of the computer-aided calculations in accordance with the requirements of (2) with the step of change in the angle φ equal to 0.1° (0.01°; 0.001°) if, for example, a=10 cm, are shown in the table (only for specific angles φ). The results of these calculations indicates: the properties of the tractrix-pseudo-sphere are like that the value of x for φ=180.0° and φ=0.0° has the limit, that is

$${lim}_{{ϕ -> 180 , 0 °}_{ϕ -> 0 , 0 ° }} = const = \begin{matrix}+ 363 , 31 cm \\ - 295 , 87 cm\end{matrix} = 1 \qquad ( 3 )$$

TABLE

| φ (degree) | a (cm) | x (cm) | y (cm) |
|---|---|---|---|
| 180.0 | 10.0 | 363.31 | 0.00 |
| 179.9 | | 60.43 | 0.02 |
| 90.0 | | 0.00 | 10.00 |
| 60.0 | | −0.49 | 8.66 |
| 45.0 | | −1.74 | 7.07 |
| 30.0 | | −4.51 | 5.00 |
| 16.0 | | −10.01 | 2.76 |
| 0.9 | | −38.47 | 0.16 |
| 0.1 | | −60.44 | 0.02 |
| 0.0 | | −295.87 | 0.00 |

In turn, the restriction (3) indicates: the pseudo-sphere being the body infinitely extended along the asymptote X′X has the finite volume Vn. This volume is equal to the half of the volume of the sphere with the radius r=a, i.e.

Vn=Vc/2=(2/3)πa³=(1/2)(4/3)πr³ (4)

[7, p. 827].

Given that the AK has the shape of the semi-pseudo-sphere, on the basis of the restriction (3), using the illustration at the FIG. 4, we can come to the conclusion: since the lines of the magnetic field \vec{H} of the action of the current is tangential to the winds of the induction coil of the AK—the inner surface of the AK, as well as the segment a=const to the tractrix—the inner surface of the pseudo-sphere, so they also have the limit (3) (they are not closed, they are quantized).

As the consequence, the restrictions (3) taking into account (4) lead the dependence (1) to:

(5)
where VnAK—the volume of the semi-pseudo-sphere of the AK with a=const; Vn—the volume of the electromagnetic field of the AK with l=const; meanwhile because, according to the table and (3)l>>α, Vn>>VnAK≈0. It is essential that the equality sign in the relation (5) is valid when, at the equal values div└\vec{E}\vec{H}┘ and −div└\vec{E}_{⊕}\vec{H}_{⊕}┘, the upper limit of the integration dVn is equal to the upper limit of the integration dV_{π⊕}. But, as the upper limit of the integration dV_{π⊕} can be greater and significantly greater than the upper limit of the integration dVn, so the right side of the relation (5) can be greater and much greater than the left.

This conclusion is crucial to determine the source of the excess electromagnetic energy of the generator of the FIG. 1. That is, the inequality sign in the relation (5) states that

$${\int }_{{V}_{Π AK} = \frac{1}{2} ( \frac{2}{3} π {a}^{3} ) \approx 0}^{{V}_{Π} = \frac{1}{2} ( \frac{4}{3} π {l}^{3} )} div [ {E}^{->} {H}^{->} ] d {V}_{Π} \leq - {\int }_{{V}_{Π ⊕}} div [ {{E}^{->}}_{⊕} {{H}^{->}}_{⊗} ] d {V}_{Π ⊕} ,$$

during the extraction of the electromagnetic energy within the volume Vn=1/2·(4/3·πl³), this energy is replenished at the expense of the volume V_{π⊕}>>Vn—this energy is generated by the electromagnetic field of the Earth from the volume V_{π⊕}>>Vn.

As the result, the dependence (5) proved that the generator at the FIG. 1 have the first required property mentioned above. The next is about the second property—the ability to ionize the gas molecules in the gas-discharge lamps.

In the description of the AK [6] it is justified the slowing-down (quantization) of the radiation wavelength λ in the free space to the length Δλ, the latter of which is equal, in the first approximation, to a=const, i.e.

n=c/v_{f}=λ/Δλ=λ/α|_{f=const},

where n—the slowing-down (quantization) coefficient, with c and v_{f}—the speed of the electromagnetic processes in the free space and in the limited space (l=const (3)) respectively.

However, the decrease in λ to Δλ is not the limit of the decrease, if we pay the attention to the spatial properties of the pseudo-sphere outside the AK, which are imposed on the lines of the magnetic field \vec{H} outside the AK.

Indeed, since the all points on the outer surface of the pseudo-sphere are hyperbolic—discontinuous in space [8, 263], so the outer lines of the magnetic field of the wires-points (in the section) of the inductive coil of the AK are also discontinuous in space—not closed (limited). This is illustrated in FIG. 4, which also shows the lines of the electric field, lines being concentrated on the imaginary capacities of these wires with respect to the environment—the physical vacuum.

The discontinuity of the lines of the magnetic (and electric) field of each wire of the AK with the diameter Ø=const leads to the decrease of the quantity Δλ to Δλ* and, in general, to the increase of the slowing-down (quantization) coefficient—

n*=c/v*_{f}=λ/Δλ*=λ/Ø|_{f=const} (6)

where v*_{f}—the speed of electromagnetic processes on the outer surface of the AK.
Deriving from (6) we have the equality

The result (7) leads to the conclusion: if the inductive coil of the AK is wound around by the wire with the diameter 0.1-1 mm, then the wavelength (7) is capable, according to [9, p. 396], ionize the gas molecules, causing the gas to glow.

As the result, equality (7) proved that the generator at the FIG. 1 have also the second required property mentioned above. This equality complements the dependence (5) in the form of

$${( {\int }_{{V}_{Π AK} \approx 0}^{{V}_{Π} = \frac{1}{2} ( \frac{4}{3} π {l}^{3} )} div [ {E}^{->} {H}^{->} ] d {V}_{Π} \leq {\int }_{{V}_{Π ⊕}} - div [ {{E}^{->}}_{⊕} {{H}^{->}}_{⊕} ] d {V}_{Π ⊕} )}_{{f = const }_{{Δλ}^{*} = Ø }} \qquad ( 8 )$$

Formula (8) states that the factor of the interaction of the electromagnetic energy of the AK and the electromagnetic energy of the Earth is the wave (quantum) Δλ<<=const (f=const); this wave, when placed the discharge lamps around the AK, is also the factor of the ionization (formalized by the arrow [symbol] ) of the molecules in the gas discharge lamps, causing the gas to glow.

Let us consider the experiment now.

FIG. 5 shows schematically the experimental conditions, where
1—AK, which has the following data:
a) α=10 cm;
b) the number of the turns—375 turns of the wire PELSHO, 0,23 mm;
c) the length of winding is limited along the x-axis to x₁=α=10 cm, φ=16° (see the table).
2—The source of the consumed (expenditure) energy (generator of G3-112/1 type with the amplifier G3-112/1);
3—Four discharge lamps (the standard daylight lamps of type LB-20: length—62 cm, diameter—4 cm, power—20 watts) [10, p. 252];
4—Oscilloscope (C1-83 type), whose input is connected to the antenna A (the segment of the ware with the length 10 cm);
R—16 ohm resistor
V1, V2—Voltmeters (V7-26 type).

The AK (with the aforementioned data) resonates at the frequency f=600 kHz (λ=500 m), meanwhile the voltmeters V1 and V2 record voltages U₁=18 V and U₂=17 V, respectively, which allow us to calculate the current through the AK

I=(U₁−U₂)/R=(18−17)/16=0.062(A) (9)

The voltage on the AK U₂=17 V and the current (9) allow us to calculate the expenditure power P_{B} (Expenditure energy per unit time of 1 second)

P_{B}=U₂I=17·0.062=1.02(W) (10)

Meanwhile, on the oscilloscope screen observed the effect of the electromotive force E, whose value is proportional to the electric field intensity E, which produced by the AK, that is

where h−The length of the antenna A, (11)
1—The value of E is normalized to unity.

Controlled values (9) and (11) define the initial mode of the generator.

The parameters of the LB-20 lamps can be controlled either by the luminous flux (700 lumens), or by the power (20 watts), or by the luminous efficiency [11, p. 203]. In the experiment, the power was controlled, which, according to [12, p. 110, p. 238], characterizes the flow of optical radiation.

The studies of LB-20 lamps ascertained:

ε≈Eh=1

a) At the nominal conditions (mode), they consume the power

R_{H}=U_{H}I_{H}=63 V·0.32 A=20.16 W;

b) At the mode of quenching (at the moment of quenching)—

R_{G}=U_{G}I_{G}=75 V·0.013 A=0.98 W (12)

The essence of the experiment is as follows.

First step.
Four lamps LB-20 are approaches to the AK, meanwhile:
a) at l=0.15 m lamps lights up (illuminates);
b) the quantities (9) and (11) changes, indicating the detuning of the resonant circuit of AK and spending the part of the energy of the source 2 on the ignition of four lamps LB-20.

These results do not provide an opportunity to assess the relationship between expenditure power and the power of 4 lighted lamps LB-20, since the latter power is not monitored.

### Second Step.

The same four lamps move away from the AK, meanwhile the following results are observed:

a) At 1=0.3 m the light flux from the lamps is reduced, while for l=0.6 m the lamps are at the brink of quenching or quench;
b) The quantities (9) and (11) do change neither at l=0.3 m, nor, all the more, at l=0.6 m; that is the quantities (9) and (11) correspond to the value of the initial mode of the operation of the generator, in which the expenditure capacity is the quantity (10).

The results of the second step, gives us the opportunity to assess the relation between the expenditure power and the (output) power of the 4 lamps LB-20 in the mode of quenching, that is, when l=0.6 m, on the basis of (10) and (12)

P_{B}<4·P_{G}(1.02<4·0.98). (13a)

There is no doubt that when l=0.3 m

P_{B}<<4·(k P_{G}) (13b)

where k>1—the coefficient of proportionality, by which the luminous flux of 4 lamps at l=0.3 m is more then the flux at l=0.6 m.

Numbers 4 and 4k in (13a) and (13b) determine the volume of the excess power (energy) versus the consumed (expenditure) power (energy), which is by the electromagnetic field of the AK excites the electromagnetic field of the Earth and cause the 4 lamps LB-20 to glow (FIG. 1).

It is essential that the fluorescent lamps in the generator of the FIG. 1 operate without the starter, the choke and the capacitor that are required in the circuits were these lamps powered from the electrical mains; the electrodes—the filament heaters is not functionally necessary as well, and can be removed.

### LITERATURE

[1] Kosinov N. V., Garbaruk V. I. The world is approaches to the vacuum energy.// The physical vacuum, and nature. Cherkassy. VVP “Mriya”. N22, 1999.
[2] Fedotkin I. M, Borovskiy V. V. Excess energy and the physical vacuum. Vinnitca. “Pres-Real”, 2004.
[3] Kriuk V. G. Natural system of units based on units of natural time. Kiev, “HaGar”, 2001.
[4] Kriuk V. G. Time and relativity. Kiev, “HaGar”, 2004.
[5] Vitaly G. Kriuk. Natural Time And Its Properties, in Cs. Vagra, I. Diens & R. L. Amoroso (eds.) Unified Theories, The Noetic Press, Orinda, USA, 2008.
[6] Kriuk V. G. Kriuk Antenna. Kiev, Ukrainian Patent No. 79626, Bull. No. 10, 2008.
[7] Vygotsky M. Ya. Reference book of higher mathematics. Moscow, “Gosisdat”, 1963.
[8] Bronstein N. N., Semindyaev K. A. Reference book of mathematics. Moscow, “Nauka”, 1969.
[9] Javorskiy B. M., Detlaf A. A. Reference book of Physics. Moscow, “Nauka”, 1980.
[10] Aisenberg Yu. B. Reference Book on lighting engineering. Moscow, “Energoizdat”, 1995.
[11] Rvachev V. P. Introduction to biophysical photometry. Lvov. Publishing house of Lvov University, 1966.
[12] Chertov, A. G. Units of physical quantities. Moscow, “Vysshaya Shkola”, 1997.

Translation of Claim of PCT-UA2010-000004

1. The generator of excess electromagnetic energy is different in that illuminating gas discharge (fluorescent) lamps, which powered mainly by the electromagnetic energy of the environment, are placed around the Kriuk antenna which powered by the source of expenditure (consumed) energy.
